(19) United States
(12) Patent Application Publication
(10) Pub. No.: US 2026/0368339 A1
(43) Pub. Date: Nov. 19, 2026

(54) SECURE OPERATION OF REDUNDANT, ONE-ERROR-TOLERANT CONTROL DEVICES IN A VEHICLE WITH SIGNED SIGNALS

(71) Applicant: VOLKSWAGEN AKTIENGESELLSCHAFT, Wolfsburg (DE)

(72) Inventor: Dirk Dreyer, Stadthagen (DE)

(21) Appl. No.: 19/126,532

(22) PCT Filed: Sep. 27, 2023
(86) PCT No.: PCT/EP2023/076705

§ 371 Date: May 1, 2025

(30) Foreign Application Priority Data
Nov. 2, 2022 (DE) 10 2022 211 587.2

(51) Int. Cl. G06F 21/60

(52) U.S. Cl. CPC G06F 21/602

(57) ABSTRACT

The present disclosure provides a one-error-tolerant control system for a vehicle that includes redundant communication over a primary data path and an encrypted secondary data path. The system is configured to perform actions based on the communication transmitted via the primary data path and compare the communication received via the primary data path with the decrypted communication received via the secondary data path. When the comparison indicates a difference, the system deactivates encryption on the secondary data path and performs actions based on the communication received via the secondary data path.

### RELATED APPLICATIONS

The present application claims priority to International Patent Application No. PCT/EP2023/076705 to Dirk Dreyer, filed Sep. 27, 2023, which claims priority from German Patent App. No. DE 10 2022 211 587.2, filed Nov. 2, 2022, the contents of each being incorporated by reference in their entirety herein.

### TECHNICAL FIELD

Aspects of the present disclosure relate to an error-tolerant, (e.g., one-error-tolerant) control system for a vehicle comprising a primary data path and a secondary data path for the communication from a first module to a second module, wherein the first module comprises a transmit component and an encryption component, connected to the transmit component; the second module comprises a receive component, a decryption component, connected to the receive component, a comparison component, connected to the receive component and the decryption component, and an action component, connected to the receive component; and the system furthermore has a primary data path and a secondary data path for the communication between the transmit component and the receive component, the action component being configured to carry out actions based on the unencrypted communication received via the primary data path.

### BACKGROUND

Such a one-error-tolerant control system is known from DE 10 2013 200 535 A1. The known system is based on the concept of transferring an electronic or mechatronic vehicle control system or the like and/or an underlying data or communication network in such a system, via which the control devices communicate with one another, into a safe operating state, for example into an emergency operating mode, after a violation of the data integrity or a safety-relevant data manipulation was recognized. A redundant network approach is used in the process, in which at least safety-related data or messages are transmitted separately or independently of one another via at least two different communication channels or paths, which in particular are separated from one another in terms of communication, to a control device receiving the data or messages. The at least two separately received data or messages can then undergo a plausibility check or verification with respect to one another, for example by way of a simple comparison. If the comparison shows deviations between the separately received data or messages, the absence of data integrity and/or the presence of data manipulation are inferred.

The described network redundancy can be implemented by a network architecture comprising at least two different networks or sub-networks of a higher-level network, wherein the safety-related input variables are always transmitted via the at least two networks to the respective control devices.

A controller is likewise known from DE 10 2013 114 355 A1, which can be operated for transmitting digital data messages to a receiver via a communication link, which provides at least one first and one second transmission path, a first signal port for the first transmission path, and a second signal port for the second transmission path. The first signal port can be operated for digitally transmitting a first message to the receiver according to a first transmission technique, while the second signal port can be operated for digitally transmitting a second message to the receiver according to a second, other transmission technique. A content transmitted by the first and second messages by way of the different transmission techniques is identical. This may be used to enhance the reliability insofar as the content can still be transmitted to the receiver or be received by the same even if an error occurs with one of the transmission techniques.

### SUMMARY

The present disclosure provides a one-error-tolerant system with improved security, including the encryption component in the first module and the decryption component in the second module that are configured to decrypt the communication via the secondary data path, wherein the action component of the second module is configured to carry out actions based on the unencrypted communication received via the primary data path, and the comparison component is configured to compare the communication received via the primary data path with the decrypted communication received via the secondary data path, and, when the comparison shows that the communication received via the primary data path and the decrypted communication received via the secondary data path differ from one another, to instruct the first module to deactivate the encryption of the secondary data path, and to instruct the action component of the second module to carry out actions based on the unencrypted communication received via the secondary data path.

These features ensure that a time-critical communication between the first and second modules occurs efficiently while meeting security requirements, as at least one unencrypted communication, which is thus not slowed by encryption or decryption, exists at all times between the first and second modules. Any manipulation of this unencrypted communication is detected because the comparison information is communicated on the secondary data path in encrypted form, ensuring protection from manipulation.

The advantage is that the communication between the first module and the second module is time-critical, and the unencrypted communication is designed to meet time objectives under normal circumstances.

The connection between the receive component, the decryption component, the comparison component, and the action component of the second module is an internal control device communication within the second module that is not accessible from the outside. This internal control device communication is designed to be secure from manipulation.

The comparison of the communication received via the primary data path with the decrypted communication received via the secondary data path in the comparison component includes a check of whether the data of the communication received via the primary data path are functionally identical to the data of the decrypted communication received via the secondary data path.

The comparison component is also designed to generate an error signal when the comparison shows that the communication received via the primary data path and the decrypted communication received via the secondary data path differ from one another, and the control system is designed to receive the error signal and, in response, bring the vehicle into a safe state.

The encryption component and the decryption component are designed to perform the communication using symmetric encryption, in particular, DES, 3DES, AES, IDEA, Blowfish, Twofish, QUISCI, CAST-128, CAST-256, RC2, RC4, RC6, Serpent or one-time pad, or asymmetric encryption, such as RSA, McEliece, Rabin, Chor-Rivest, Elgamal, elliptic curve cryptography or Merkle/Hellman.

The primary data path and/or the secondary data path includes a bus connection, such as Fieldbus, Modbus, CAN, CanOpen or MVB. The first (primary) data path particularly advantageously comprises a first bus connection, and the secondary data path comprises a second, independent, bus connection.

In another aspect, the present disclosure provides a method for the one-error-tolerant control of a vehicle, comprising: generating a redundant communication from a first module to a second module, by means of a primary data path and a secondary data path; transmitting the redundant communication from the first module to the second module via the primary data path and the secondary data path, the transmission via the secondary data path taking place in encrypted form; carrying out, in the second module, an action based on the communication transmitted via the primary data path; comparing, in the second module, the communication received via the primary data path and the decrypted communication via the secondary data path; and, when the comparison shows that the communication received via the primary data path and the decrypted communication received via the secondary data path differ from one another: instructing the first module to no longer encrypt the communication via the secondary data path; and instructing the second module to carry out actions thereafter based on the communication received via the secondary data path.

Further aspects of the present disclosure include a computer-readable memory storage containing information that, when they are executed on one or more processors, cause the processors to perform the steps of the method described herein, and a vehicle including a redundant control system as described herein.

### BRIEF DESCRIPTION OF THE DRAWINGS

Exemplary embodiments of the present disclosure will be described hereafter based on the drawings. In the drawings:

FIG. 1 shows a schematic diagram of a redundant control system, according to some aspects of the present disclosure;

FIG. 2 shows a flow chart of a method, according to some aspects of the present disclosure; and

FIG. 3 shows a vehicle in which the redundant control system can be used, according to some aspects of the present disclosure.

### DETAILED DESCRIPTION

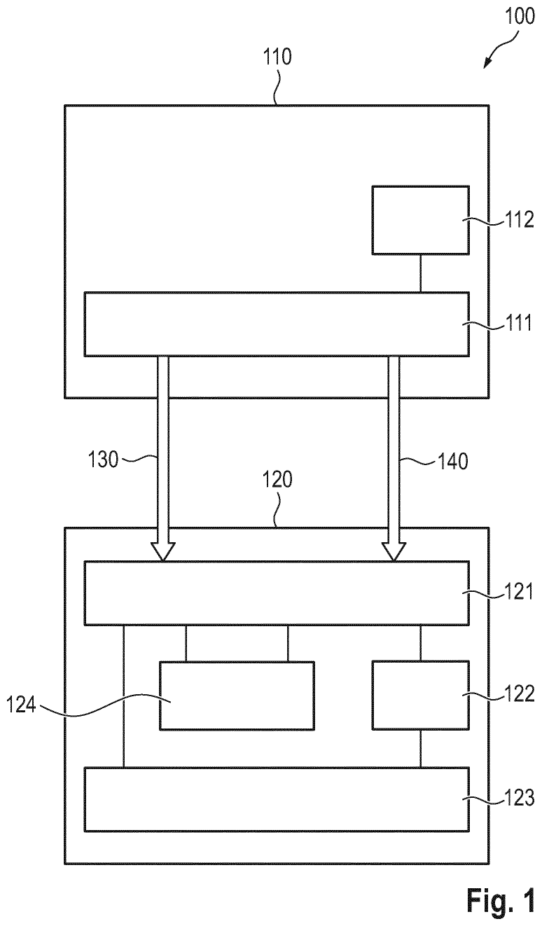

FIG. 1 shows a schematic diagram of a system 100 according to one specific embodiment of the present disclosure. A first module 110 and a second module 120 are communicatively connected by a first, primary data path 130 and a second, secondary data path 140, including two bus connections 131, 141. The first module 110 includes a transmit component 111 and the second module 120 includes a receive component 121, both connected to the primary data path 130 and the secondary data path 140. The first module 110 also includes an encryption component 112 and the second module comprises a decryption component 122, connected to the respective transmit component 111 and receive component 121.

The second module 120 also includes a comparison component 123 and an action component 124, communicatively connected, advantageously by an, in particular manipulation-safe, internal control device communication of the second module 120, via a secure internal control device communication within the second module 120 to the receive component 121, wherein the decryption component 122 is connected between the receive component 121 and the comparison component 123.

During normal operation, the first module 110 generates a functionally identical communication, which contains equivalent data and instructions but may differ, for example, in the header and/or the encoding, both via the primary data path 130 and the secondary data path 140. The communication via the secondary data path 140 is encrypted with the aid of the encryption component 112.

The second module 120 receives the communication through both the primary data path 130 and the secondary data path 140 and, using the action component 124, carries out an action corresponding to the data and instructions received via the primary data path 130. These actions are executed quickly since no encryption and decryption of the communication via the primary data path 130 are necessary, thereby advantageously adhering to the time limits of a security protocol.

Simultaneously, the comparison component 123 compares the communication via the primary data path 130 with the decrypted communication via the secondary data path 140. When the comparison reveals a functional difference between the transmitted instructions and data, this indicates potential manipulation of the primary data path 130. In this case, the first module is instructed to cease encrypting the transmission via the secondary data path 140, the action component 124 is instructed to base future actions on the data and instructions received via the now unencrypted secondary data path 140, and, advantageously, the control system is directed to bring the vehicle into a safe state, specifically to a halt.

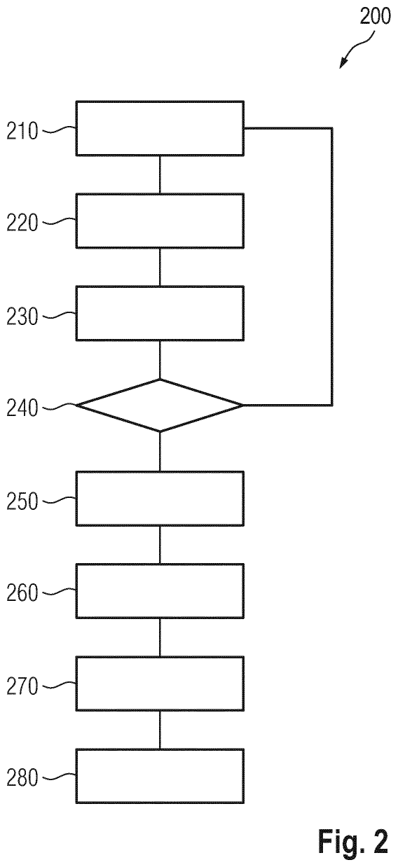

FIG. 2 shows a flow chart of a method according to one specific embodiment of the present disclosure. In the first step 210, a redundant communication between the first module 110 and a second module 120 via a primary data path 130 and a secondary data path 140 is generated. In the subsequent transmission step 220, the redundant communication from the first module 110 to the second module 120 is transmitted via the primary data path 130 and the secondary data path 140, using a first and a second bus system, wherein the transmission via the secondary data path 140 takes place in encrypted form.

As a result of the received communication, the second module 120, in the action step 230 that follows, performs an action based on the communication transmitted via the primary data path 130. Since the communication via the primary data path 130 is in unencrypted form, potential time limits for performing the action are met under normal conditions.

Likewise, as a result of the received communication, and in part parallel to the action being carried out in action step 230, the second module, in the comparison step 240 that follows, compares the communication received via the primary data path 130 to the decrypted communication via the secondary data path 140. If this comparison shows that the communication received via the primary data path 130 and the decrypted communication via the secondary data path 140 are functionally identical, meaning they contain the same instructions and data, the method continues with the first step 210.

If a difference is established in comparison step 240, indicating that the transmission via the primary data channel was presumably corrupted, the method continues to the first instruction step 250. In this first instruction step 250, the first module 110 is instructed to no longer encrypt the communication via the secondary data path 140, and in the subsequent second instruction step 260, the second module 120 is instructed to carry out actions based on the communication received via the secondary data path 140. These steps allow the instructed actions to be carried out in the second module 120, and the potential time limits for carrying out the action are not violated under normal circumstances.

Following the instructions of the preceding instruction steps 250 and 260, the method advantageously also comprises further steps that ensure the security of the control system and the vehicle. These steps include generating 270 an error signal and, in response to the error signal, bringing 280 the vehicle into a safe state, particularly bringing the vehicle to a halt.

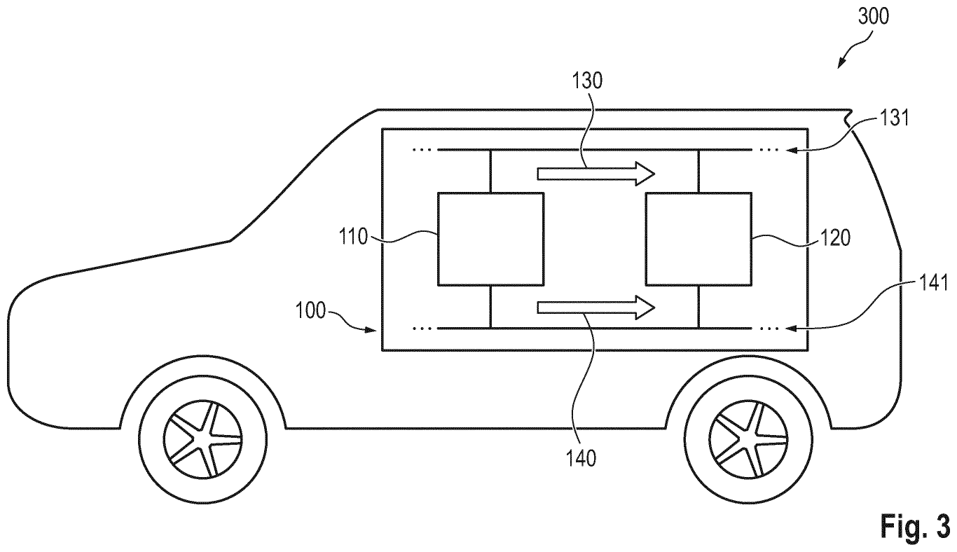

FIG. 3 schematically shows a vehicle corresponding to a specific embodiment of the present disclosure. The control system (100) is integrated into a vehicle (300). In particular, it is shown how the primary (130) and secondary (140) data paths for communication between the first module (110) and the second module (120) can be implemented using a first (131) and a second (132) bus connection.

### LIST OF REFERENCE NUMERALS

100 control system
110 first module
111 transmit component
112 encryption component
120 second module
121 receive component
122 decryption component
123 comparison component
124 action component
130 primary data path
131 first bus connection
140 secondary data path
141 second bus connection
200 control method
210 generating a redundant communication
220 transmission step
230 action step
240 comparison step
250 first instruction step
260 second instruction step
270 generating an error signal
280 bringing the vehicle into a safe state

1-15. (canceled)

16. A control system for a vehicle, comprising:
a first module configured to transmit communication; a second module configured to receive communication from the first module;
a primary data path and a secondary data path configured for communication between the first module and the second module, wherein the first module is configured to encrypt communication transmitted via the secondary data path;
wherein the second module is configured to:
decrypt communication received via the secondary data path;
perform actions based on unencrypted communication received via the primary data path;
compare the communication received via the primary data path with the decrypted communication received via the secondary data path; and
when the comparison indicates a difference, deactivate encryption of the secondary data path and perform actions based on the communication received via the secondary data path.

17. The control system of claim 16, wherein the second module is configured to check whether data of the communication received via the primary data path are functionally identical to data of the decrypted communication received via the secondary data path during the comparison.

18. The control system of claim 16, wherein the second module is further configured to generate an error signal when the comparison indicates a difference, and the control system is configured to bring the vehicle into a safe state in response to the error signal.

19. The control system of claim 18, wherein the safe state includes bringing the vehicle to a halt.

20. The control system of claim 16, wherein the first module and the second module are configured to perform the communication via the secondary data path using symmetric encryption selected from the group consisting of DES, 3DES, AES, IDEA, Blowfish, Twofish, QUISCI, CAST-128, CAST-256, RC2, RC4, RC6, Serpent, and one-time pad.

21. The control system of claim 16, wherein the first module and the second module are configured to perform the communication via the secondary data path using asymmetric encryption selected from the group consisting of RSA, McEliece, Rabin, Chor-Rivest, Elgamal, elliptic curve cryptography, and Merkle/Hellman.

22. The control system of claim 16, wherein the primary data path includes a first bus connection and the secondary data path includes a second bus connection independent of the first bus connection, the first and second bus connections selected from the group consisting of Fieldbus, Modbus, CAN, CanOpen, and MVB.

23. The control system of claim 16, wherein communication within the second module between components configured to receive, decrypt, compare, and perform actions is secure and not accessible from outside the second module.

24. The control system of claim 16, wherein the communication between the first module and the second module is time-critical, and the unencrypted communication via the primary data path is configured to meet time limits under normal conditions.

25. A method for controlling a vehicle, comprising:
generating a redundant communication from a first module to a second module via a primary data path and a secondary data path;
transmitting the redundant communication from the first module to the second module via the primary data path and the secondary data path, wherein the communication via the secondary data path is encrypted;
performing, by the second module, an action based on the communication received via the primary data path;
comparing, by the second module, the communication received via the primary data path with decrypted communication received via the secondary data path; and
when the comparison indicates a difference: deactivating encryption of the communication via the secondary data path; and performing, by the second module, an action based on the communication received via the secondary data path.

26. The method of claim 25, wherein comparing includes checking whether data of the communication received via the primary data path are functionally identical to data of the decrypted communication received via the secondary data path.

27. The method of claim 25, further comprising: generating an error signal when the comparison indicates a difference; and bringing the vehicle into a safe state in response to the error signal.

28. The method of claim 27, wherein the safe state includes bringing the vehicle to a halt.

29. The method of claim 25, wherein transmitting the communication via the secondary data path includes using symmetric encryption selected from the group consisting of DES, 3DES, AES, IDEA, Blowfish, Twofish, QUISCI, CAST-128, CAST-256, RC2, RC4, RC6, Serpent, and one-time pad.

30. The method of claim 25, wherein transmitting the communication via the secondary data path includes using asymmetric encryption selected from the group consisting of RSA, McEliece, Rabin, Chor-Rivest, Elgamal, elliptic curve cryptography, and Merkle/Hellman.

31. The method of claim 25, wherein the primary data path includes a first bus connection and the secondary data path includes a second bus connection independent of the first bus connection, the first and second bus connections selected from the group consisting of Fieldbus, Modbus, CAN, CanOpen, and MVB.

32. The method of claim 25, wherein communication within the second module for receiving, decrypting, comparing, and performing actions is secure and not accessible from outside the second module.

33. The method of claim 25, wherein the communication between the first module and the second module is time-critical, and the communication received via the primary data path is configured to meet time limits under normal conditions.

34. A non-transitory computer-readable storage medium storing instructions that, when executed by one or more processors, cause the one or more processors to perform operations for controlling a vehicle, the operations comprising:
generating a redundant communication from a first module to a second module via a primary data path and a secondary data path;
transmitting the redundant communication from the first module to the second module via the primary data path and the secondary data path, wherein the communication via the secondary data path is encrypted;
performing, by the second module, an action based on the communication received via the primary data path; comparing, by the second module, the communication received via the primary data path with decrypted communication received via the secondary data path; and
when the comparison indicates a difference: deactivating encryption of the communication via the secondary data path; and performing, by the second module, an action based on the communication received via the secondary data path.

35. The non-transitory computer-readable storage medium of claim 34, wherein comparing includes checking whether data of the communication received via the primary data path are functionally identical to data of the decrypted communication received via the secondary data path.
